(19) United States
(12) Patent Application Publication
(10) Pub. No.: US 2002/0141545 A1
(43) Pub. Date: Oct. 3, 2002

(54) Efficient autocorrect hearing aid coupling system

(76) Inventor: Jacob Lynn Segovia, Divide, CO (US)

Correspondence Address: Jacob L. Segovia, 789 Ridge Drive, Divide, CO, 80814, US

(21) Appl. No.: 09/820,777

(22) Filed: Mar. 30, 2001

(51) Int. Cl. H04M 11/00

(52) U.S. Cl. 379/52

(57) ABSTRACT

A plastic cup (10) that contains a electromagnetic induction coil (8) and a autocorrect circuit (32, 34, 36, 38, 40, 42) that is used to magnetically transfer the audio signal from a telephone handset's speaker (22) to a “T” coil equipped hearing aid (28) (any type, make or model). The present invention mounts to, and is connected to, the telephone handset speaker (22). Powered directly from the telephone handset speaker (22,) the magnetic coil (8) now concentrates and directs the magnetic field to any “T” coil equipped hearing aid (28). Included in the present invention is an autocorrect circuit (32, 34, 36, 38, 40, 42) that limits the frequency response of the eletromagnetic induction coil (28). In addition, people with normal hearing can use the very same telephone handset (20) as the telephone handset speaker (22) is left fully operational, with normal sound pressure levels.

### BACKGROUND

There are more than 32 million people with hearing disabilities alone in the United States. The worlds population of hearing impaired totals close to 480 million people are presently unable to just pick up a telephone and use it.

The referenced population on the whole currently does not have access technology, nor the capability of using and hearing on a telephone for any reason, anywhere . . . in the world.

A number of TTY products (telecommunications devices for the deaf-text) are available in the marketplace. These products are typically nothing more than terminals that transmit typed messages over telephone lines to a compatible terminal or to relay operators at the receiving end of the line. These prior art TTY terminals are disadvantageous in that they do not meet the full accessibility needs of hearing impaired persons. According to the Tele-Consumer Hotline, less than one-half million people with hearing loss utilize a TTY for telecommunications, due to the desire for voice telecommunications. It should also be pointed out that this technology is over 50 years old.

Sound amplification products also exist in the prior inventions (See references cited), but they clearly do not amplify to the extent required to truly benefit a hearing disabled person. The 18-30 decibels of amplification typically realized from these prior invention amplification products will not benefit a person suffering from even a moderate hearing loss, let alone one who is severely to profoundly deaf or more so.

Use of standard telephones with volume control, dual volume control, hearing aid compatible handsets, hearing aid telephone interconnect systems, and other products, only address access for less than 10% of the population worldwide, those that have a mild to moderate hearing loss. These prior inventions fail to meet the true needs of the population who need hearing access.

Prior inventions of hearing aid compatible or interconnect systems do not provide the power or the signal strength capture needed to directly couple to ensure maximum hearing access needed by millions of hearing aid users today. Either a person with a hearing disability can't hear any sounds upon using one of these devices or they can hear something, but are unable to understand any words of what is being said to them via these types of devices. Or they cannot maintain a direct capture of the signal strength to hold the sound transmission, thus what is known as the “dead spots” (no sound transmission occurs,) according to the population who have tried to use these types of systems. It has been proven before the Federal Communications Commission, including the Department of Engineering, that hearing aid compatible phones, volume control and dual volume control handsets performance levels are the same. The result is the equivalent of raising the sound volume just a small amount. This results whether one uses a hearing aid or not. Historically, people with more than a mild hearing loss will not touch a labeled hearing aid compatible phone, as overall they have never been able to hear adequately at any level using these products.

Therefore, the remaining 90% of the world population of people with hearing loss (over 480 million people) still cannot access voice telecommunications or communications. They have been denied access, convenience, and in many instances, the life saving benefits of both wired and wireless phone usage in homes, offices, hotels, airports, restaurants, hospitals, banks, job sites, pay phones, and more. The realm of emergency phone access is even more of an issue, given the appalling limitations of hearing access technology currently available for public use. This is quite self evident in the emergency phones located every ten miles along some of America's highways. 100% are not hearing accessible to people with more than a mild hearing loss!

This is equally as evident in the public accommodations (payphone) telecommunications arena. There are currently over 120 million payphones in the U.S. All of the payphones that are currently deemed hearing aid compatible or have volume controls, or have TTY's affixed to them, only allow those individuals with mild to moderate hearing loss or those without hearing aids, access to these phones. Again, providing no access and usage by the remaining 90% of the population with hearing loss in the United States, due to inability to hear voice communications clearly on prior inventions.

Traditionally, it has been normal practice to take the audio signal that is present in the environment, and electronically magnetically induce it into the hearing aid of such person. This serves to circumvent an inherent problem with hearing aids, that of corruption of the audio signal as it is received by the hearing aid device itself.

For nearly 30 years, manufacturers have relied on a device known as the induction coil to accomplish this. For whatever reasons, be it poor designing, or lack of knowledge, virtually all of the devices on the market fall far short of delivering a quality audio signal to the hearing aid device.

Information relevant to attempts to address these problems can be found in U.S. Pat. No.:

U.S. Pat. No. 4,160,122 to Jacobson, 1979

U.S. Pat. No. 4,543,453 to Brander, 1985

U.S. Pat. No. 4,596,899 to Wojeik et al, 1986

35 08 830 A1 to DE, 1986

0 313 776 A2 to EP, 1989

U.S. Pat. No. 5,537,472 to Estevez-Alcolado, 1996

2 292 287 to GB, 1996

U.S. Pat. No. 5,796,821 to Crouch et al, 1998

PCT/US9721930 to WO, 1998

U.S. Pat. No. 5,991,420 to Stern, 1999

However, each one of these references suffers from one or more of the following disadvantages.

1) Dependency on the need for batteries. When the inventions battery dies out, and no replacement is available, the user is left with an invention that does not work.

2) Complexity of operation. Many of these inventions require the user to ascertain that switches and controls are set in an exact manner to perform one aspect of operation, and that these same controls must be set up in a different fashion to achieve another function. The result is the user is frustrated and confused by the complexity of operating the invention.

3) Difficulty in setting up and installing the invention. Many of the cited inventions require an assortment of cables, wires and cords to be installed in an exacting manner. The possibility of the user miss wiring the invention is high, thus the user is left with an invention that he/she cannot figure out how to hook up.

4) Nondiscretion of many of the examples cited. Many of the cited inventions propose that the user wear bizarre and outrageous pieces of headgear to benefit from the invention. Some of the cited prior arts inventions make the user feel foolish and silly in using the invention, and many users are just too embarrassed to use the devices, in both public and private settings.

5) Performance ineffectiveness in allowing people with moderate to severe hearing loss or profound or total deafness to be able to hear. Virtually all of the cited inventions fail to provide the user the means to access the true audio content of the medium received, this being because most couplers that are typical of today's couplers, in that they rely on t echnologies that do not promote the capture of all the audio that is present.

6) Performance stability of the invention. Many of the cited inventions are unable to eliminate the “dead spots” in signal transmission, thereby rendering the user unable to hear anything without constant readjustment and placement of the cited inventions coupler.

7) Such prior art also does not allow a person with normal hearing to share in using the same telephone. In the case of a household that only has one telephone, or in the case of roadside emergency telephones, the need for the telephone to serve both the hearing impaired and those with normal hearing becomes apparent.

8) Also previous prior art has failed to come up with a self powered circuit that eliminates any possible signal which may cause the users hearing aid to overload, and increase the distortion levels sent to the user.

In the cited inventions, it has been a standard to employ what is known as an “open air” coil to transfer (via electromagnetic induction) a audio signal from a telephone handsets speaker to the T-coil magnetic pick up in a hearing aid. However, in utilizing the open-air coil concept for signal transfer, one comes across four drawbacks to achieving optimum performance. These four (4) drawbacks, or disadvantages, are as follows:

First, the open-air coil is inefficient, as it will waste much of the energy supplied to it. This can be explained of the fact that the open-air coil tends to radiate the electromagnetic field to the front, rear, top, bottom, and both sides of the coil. Whereas we need to transfer as much of the electromagnetic field as possible to the sides of the coil, for efficient transfer of the signal to the hearing aid.

The second disadvantage is that a typical open-air coil is wound with many hundreds of turns of magnetic wire, resulting in a resistance of the coil at (typically) 90 to over 150 ohms. This “presents” to the amplifier that is driving the open-air coil, a very high impedance, or resistance. Because of this fact, most telephones cannot run both an open air coil and the telephone handset speaker at the same time. This explains why the “HATIS” coil (U.S. Pat. No. 5,796,821) cannot be placed inside the telephone, rather it has to be used in a separate box. Today's modem solid-state “chip” amps are designed to operate a load ideally at 4 to 8 ohms of impedance. Thus, most “chip” amps used to drive an open-air coil are over specified, with the extra power needed to overcome such high impedance's. This results in the need to use larger and heavier batteries to power the coil.

The third disadvantage is the size of the open-air coil. To generate the desired electromagnetic field, they must be large, with a typical size being 1″ long by ¾″ wide. Many, users of these coils find this unacceptable for cosmetic reasons. Manufacturers of different telephone handsets also find that incorporating such a large device into their already crowded handsets is difficult at best.

The forth disadvantage is that open-air coils are logarithmic devices. This means that this type of coil has very low output at lower to middle frequencies, while at the same time they have far more output at higher frequencies. This disadvantage reflects in that the user will tend to mainly hear sounds that are higher in frequency than they wish. Also this ability for the coil to be more efficient at just the higher frequencies means that very often it will send frequencies that are above the limits of the hearing aid, which will add increased distortion levels that are sent on to the user.

For the foregoing reasons, there is a need for a highly efficient and powerful hearing aid coupling system with maximum sound transfer ability and stability, coupled with a completely automatic ability to control the response of the coil, so that users can experience all of life's sound in a more natural balance.

This invention is not only needed by the end user but indeed by the telecommunications industry to provide hearing accessible equipment and services to people with hearing disabilities worldwide.

### SUMMARY

It is the principle object of the present invention to provide a superior, highly effective means of coupling the audio signal from a wired telephone to a hearing aid (any type or any model) that is equipped with a T-coil pick up, using advanced management of the invention itself. This will satisfy the needs for: 1) an invention that does not require batteries in order to work, 2) Simplicity of usage of the present invention, simply placing the telephone handset next to the hearing aid/head, 3) No external switches, wires, cables, or cords are necessary to operate the present invention, 4) No visible evidence of outrageous headgear used in operating the present invention, 5) Present invention captures the signal to ensure solid audio sound transmission for all levels of hearing loss, to the users hearing aid equipped with a T-coil, 6) No adjustment or re-placement of present invention is required, 7) Present inventions completely automatic control circuitry, 8) Lastly the present invention satisfies the requirement for normal hearing people to be able to use the very same phone, as the speaker in the telephone handset is left completely operational, and fully functional.

The present invention manifests itself in the form of an inductor wound around a rare earth toroid core, thus magnifying the magnetic fields normally associated with ordinary open-air coils. The result is a much higher flux density that is sent to the users T-coil equipped hearing aid (any type or model). This ultimately results in a higher signal to noise ratio in the hearing aid, thus generating superior clarity over cited inventions, and improved efficiency in the inventions current requirements. Also, since we desire to control the coil, so that it does not operate above 8 Khz, a compensation control circuit is also included that automatically turns on to control the coil, thus limiting it's operation from 350 Hz to 8 khz. Also, the present invention measures in at 5 mm in diameter, and just 3 mm in height!

I believe that my present invention will dramatically change everyday life for over 480 million people with hearing loss worldwide, who have yet in this day, been able to hear voice communications via a telephone. From the moment the invention is installed, it is of my opinion that word will spread like wildfire throughout the hearing impaired community. They will demand that all telephones sold through out the world be equipped with the present invention.

Perhaps those of us with hearing loss that is moderate, severe to profound, to total deafness, can finally achieve the dream that Dr. Alexander Graham Bell had for his wife who was deaf. The telephone can be the true medium of communications for all, hearing and deaf alike. The result is simple. It allows full participation in human society. This population will no longer be relegated to that of being a spectator, due to lack of technology to access sound.

### LIST OF REFERENCE NUMERALS

6) Semiconducting Magnetic Core

8) Magnetic Coil

10) Cup

12) Method of Winding the Core with Wire

14) Wire Leads

16) “HATIS” Magnetic Lines of Force

18) Present Invention Lines of Force

20) Telephone Handset

22) Telephone Handset Speaker

24) Epoxy Encapsulate

26) Magnetic Lines of Force in Telephone Handset

28) “T” Coil Equipped Hearing Aid

30) Complete Schematic

32) Resistor R1, 30 ohms

34) Resistor R2, 120 ohms

36) Resistor R3, 47 ohms

38) Zener Diode, 16 Volt

40) Transistor Q1, 2N2222

42) Printed Circuit Board

### BRIEF DESCRIPTION OF DRAWINGS

A more complete understanding of the method and apparatus of the present invention may be had by reference to the following detailed descriptions of the detailed drawings

Wherein:

FIG. 1 is a side view of the present invention.

FIG. 2 is a top view of the present invention.

FIG. 3 is a isometric view of the present invention.

FIG. 4 is a view of how the coil is wound with wire.

FIG. 5 shows the projected magnetic flux lines of prior art known as “HATIS”.

FIG. 6 shows the pattern of the magnetic lines of force projected from the present invention.

FIG. 7 shows the present invention installed into a typical telephone handset.

FIG. 8 shows the magnetic flux lines of the present invention after it is installed into a typical telephone handset.

FIG. 9 shows the complete schematic of the present invention.

FIG. 10 shows the complete part list

FIG. 11 shows the Printed Circuit Board

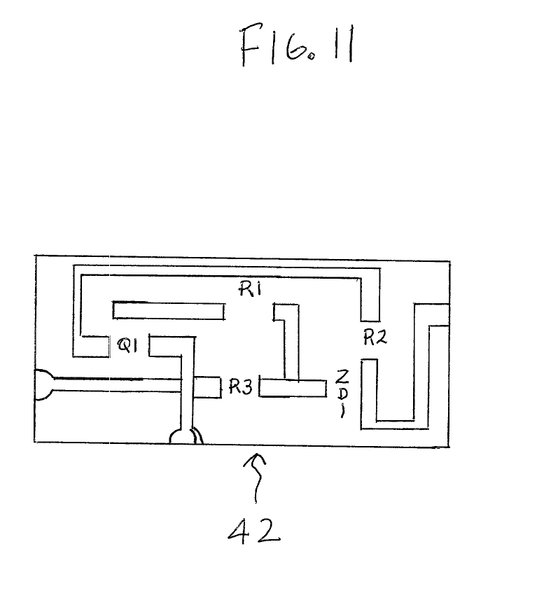

Although a preferred embodiment of the present invention has been illustrated in the drawings, and described in the foregoing Detailed Description, it will be understood that the present invention is not limited to the embodiment disclosed, but is capable of numerous rearrangements, modifications, and substitutions, without departing from the spirit of the present invention as set forth and defined by the following claims.

### DETAILED DESCRIPTION OF THE DRAWINGS

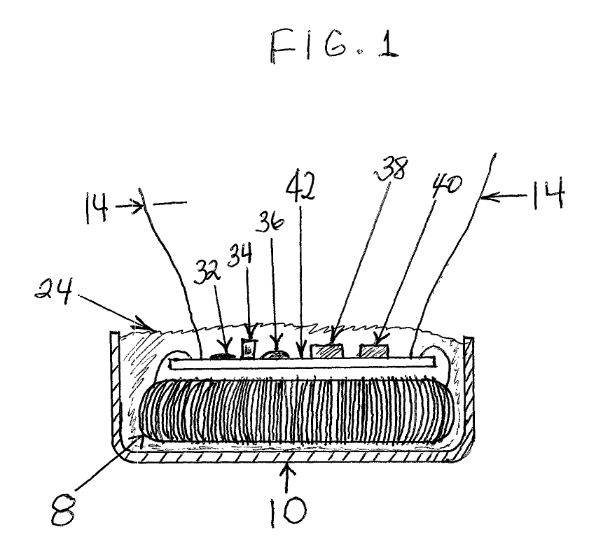

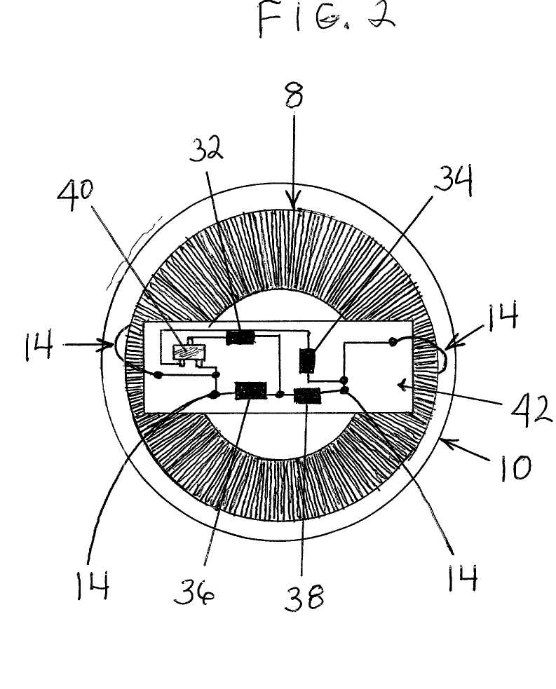

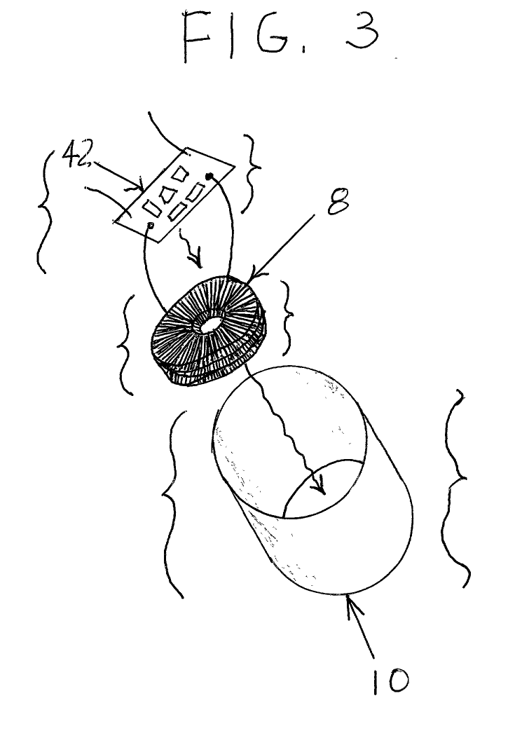

FIG. 1 shows a side view of the present invention, while FIG. 2 shows a top view, and FIG. 3 shows a isometric exploded view of the present invention. As can be seen in FIG. 1, 2, and 3, the drawings show the coil 8, Printed Circuit Board 42, (which contains components 32, 34, 36, 38, 40) sitting down inside the plastic cup 10. The ends of the wire that is wound around the core, or wire leads 14, exit the top of the cup 10. Epoxy encapsulate 24 is now poured into the cup 10, to provide a means to glue the coil 8 and it's associated components solidly to the cup 10, and protect the coil from mechanical shock, and environmental elements.

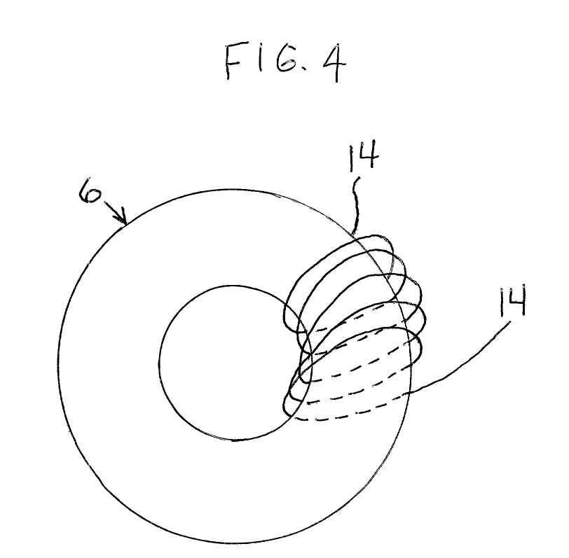

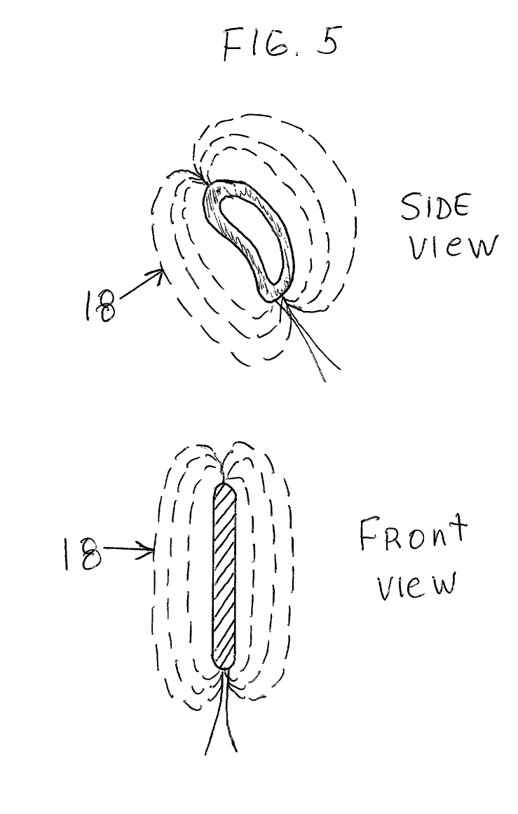

FIG. 4 shows how the ferrite core 6 is wound with 38 gauge copper wire. In a simple fashion, the wire is wound through the center of the core, around the shoulders of the core, and back through the center of the core again. This is repeated around the core in a circular manner, layer upon layer, for a total of 250 turns. After winding the coil 8, approximately 1 inch of wire leads 14 is left, for attaching to the printed circuit board 42. FIG. 5 As an example, FIG. 5 shows the resultant magnetic field emanating from a prior art “HATIS” coil (U.S. Pat. No. 5,796,821). Here can be seen how the resultant magnetic field 18 that is generated flows out and away from the “HATIS” coil in several directions. As can be seen, the magnetic energy flows to the top, bottom, sides, front and rear of the “HATIS” coil. As can be deduced by anyone familiar in the art, much energy is wasted here, as we need to send the bulk of the electromagnetic energy to the sides of “HATIS” coil, so that we may send the majority of the electromagnetic energy to the hearing aid 28.

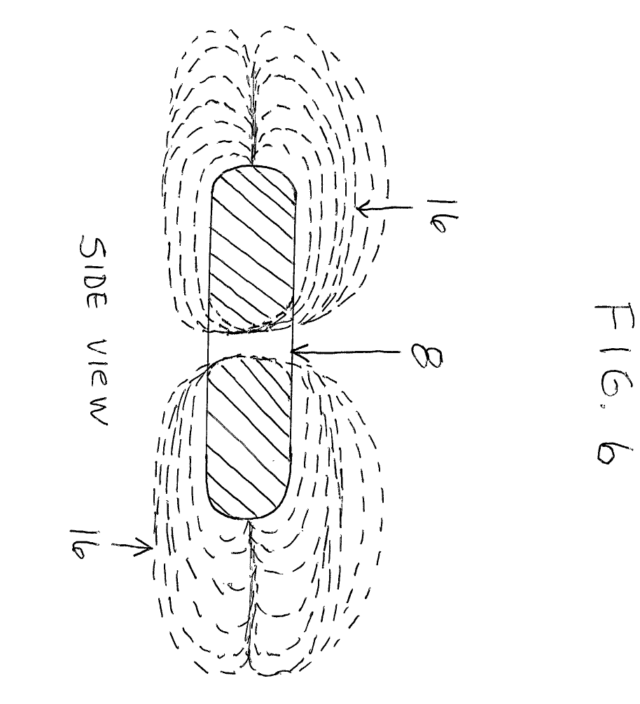

FIG. 6 Shows the resultant magnetic field emanating from the present invention. As can be seen, the electromagnetic lines of force 16 are now more tightly controlled, and are directed in a more controlled fashion. Thus we can now install the coil 8, inside a telephone handset 20 very accurately, so as to direct virtually all of the electromagnetic lines of force 16 directly to the users hearing aid 28.

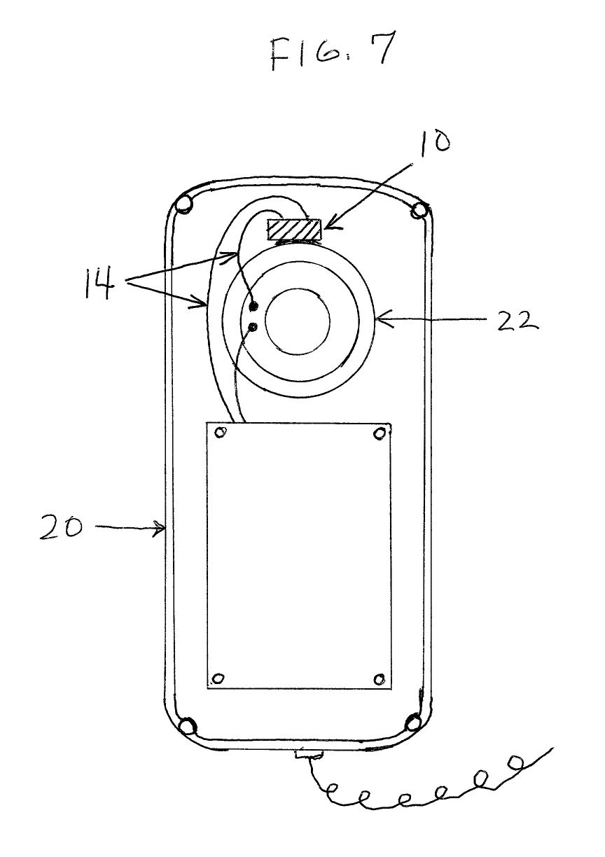

FIG. 7 shows how the present invention is mounted into a typical telephone handset 20. Here (shown from the back of the telephone handset, and with the back cover removed) the present invention is mounted on top of the handset speaker, by means of gluing the cup 10 (that contains parts 8, 32, 34, 36, 38, 40, 42) to the handset speaker 22. The wire leads 14 are then connected in series with the handset speaker 22.

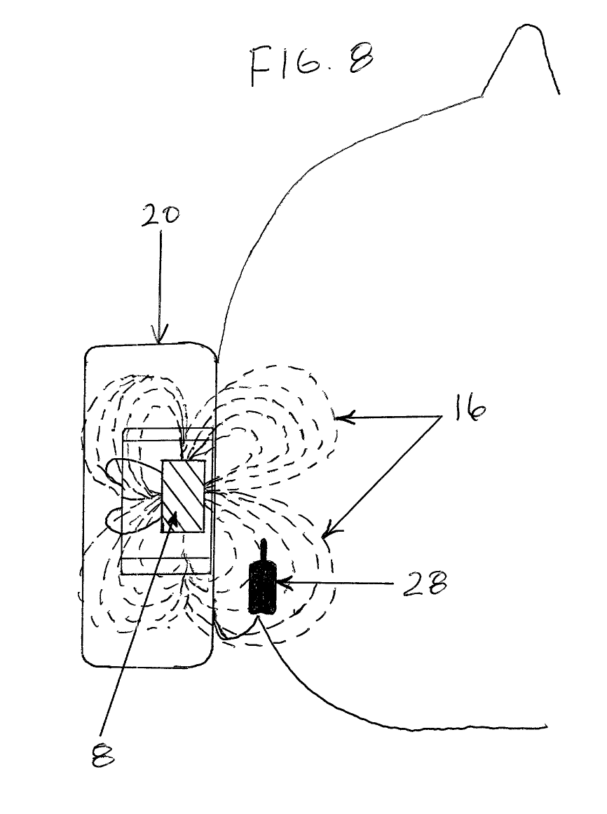

FIG. 8 shows the resultant magnetic field emanating from the telephone handset 20. This view is shown as we look down on top of the users head, and holding the telephone handset 20 next to his/her ear. As can be seen here, the electromagnetic lines of force 16, now flow out from the telephone handset 20 in a more direct fashion. In a sense we can now “steer” the electromagnetic lines of force 26 towards the hearing aid 28. Thus we can literally “flood” the users hearing aid with enough magnetic energy that we insure a positive lock on the signal from the telephone handset 20.

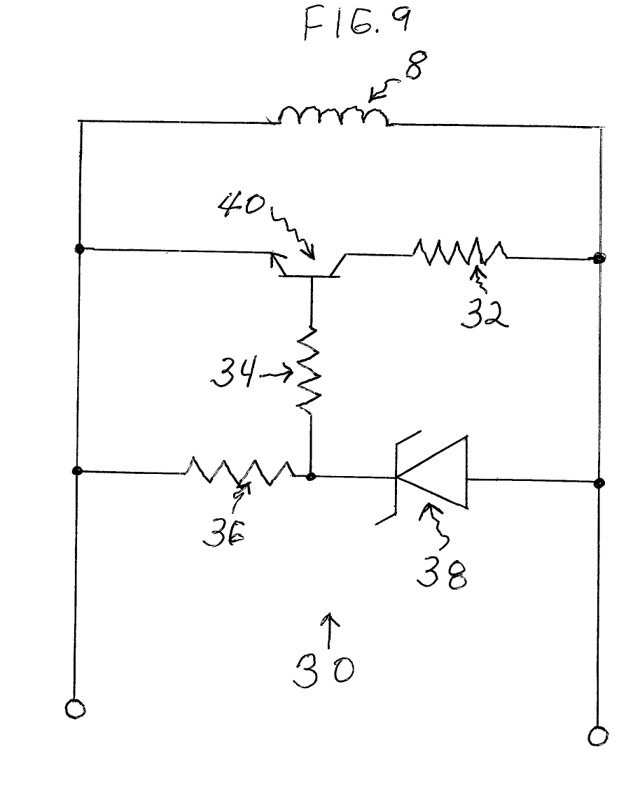

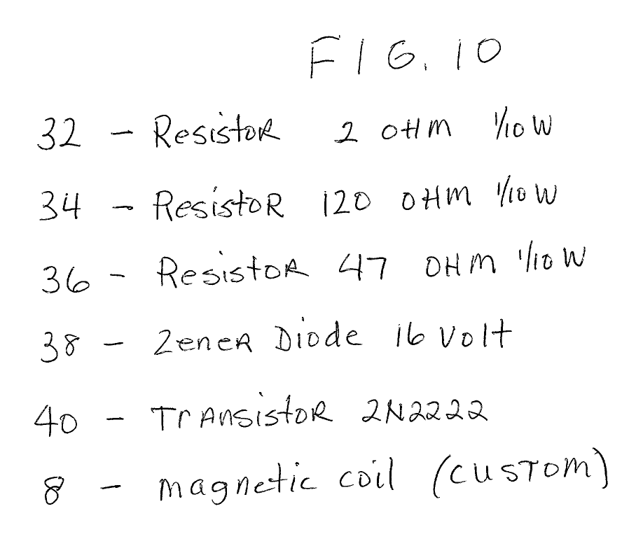

FIG. 9 shows the schematic of the present invention. As can be seen and understood by those familiar in the art, components Zener Diode 38, Resistor 32, and Resistor 36 form a voltage controlled switch, which when triggered “on,” biases transistor 40 on. In normal operation, and with the signal below 8 khz, component Zener Diode 38 is in an “off” state. This is because the average DC level of the signal does not provide enough bias to allow Zener Diode 38 to conduct. However, when the signal level reaches 8 khz, the DC level of the signal increases to the point where Zener Diode 38 now conducts through the bias components Resistor 34, and Resistor 36. This turns Transistor 40 “on”, which now conducts and provides a path of lower resistance or impedance of the signal. Resistor 32 limits the current flowing. Thus for the microsecond that the signal is operating above 8 khz the circuit is activated, and approximately 50% of the signal will flow through the transistor instead of the coil. This in turn lowers the output of the coil by half, thus reducing the amount of harmful frequencies that could be sent to the hearing aid 28. FIG. 10 Details the layout of the printed circuit board. As can be seen, the Printed Circuit Board is laid out to accept surface mounted components. This is required to keep the size of the printed circuit board to a size as small as possible.

### OPERATION OF THE INVENTION

The cup 10, that contains the coil 8, and components 32, 34, 36, 38, 40, 42 is attached with glue to the top of the telephone handset speaker 22. The wire leads 14 are now connected to the telephones handset speaker terminals. The present invention is wired in series with the telephone handset speaker 22, using methods familiar to anyone who is knowledgeable in electronics. To operate the present invention, one simply picks up the telephone handset 20, and places it next to the ear that has the hearing aid 28 and simply talks to and listens to, the other party. The electrical signals going to the telephone handset speaker now powers the circuit. During operation, if any electrical signal is faster than 8 Khz, Zener Diode 38 automatically conducts and it in turn biases Transistor 40 on, thus providing a means to automatically bypass 50% of any signal faster than 8 KHz. When finished with the telephone call, the user simply hands up the telephone handset 20. The present invention is completely powered by the telephone itself In the case of a normal hearing user, operation of the telephone is no different than using any other telephone, as the telephone handset speaker 22 is left fully operational.

### DESCRIPTION AND OPERATION OF ALTERNATIVE EMBODIMENTS

Although the present invention has been described in considerable detail with reference to certain preferred versions thereof, other versions are possible. For example, the present invention can be installed in, and would allow the following, to benefit from the internal coupling of my coil:

Wired desk and wall telephones, cordless telephones, cell phones, cell phone hands-free kits, cordless telephone hands-free kits, payphones, key telephone systems, telemarketer headsets, stereo headsets, stereo earbuds, and stereo ear phones, televisions sets, radios, stereos, walkman players, flight helmets, computer headsets, emergency roadside telephones, 2-way radios, walkie-talkies, aircraft and bus headsets, interactive, communications system, FM training systems, and information kiosks.

Therefore, the spirit and scope of the appended claims should not be limited to the description of the preferred versions contained herein.

The readers attention is directed to all papers and documents which are filed concurrently with this specification and which are open to public inspection with this specification, and the contents of all such papers and documents are incorporated herein by reference.

All features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

What I claim as my invention is:

1) A method to enable a hearing impaired person, (fitted with a “T” coil equipped hearing aid,) or a person of normal hearing to both access the same telephone, be it wired, cordless or cellular telephone, the method comprising the steps of:
Picking up the telephone and placing the telephone handset over the ear with the hearing aid, and using said telephone in a completely normal fashion.

2) A method whereby a semiconducting ferrite core/coil is installed internally in a telephone handset, with the intent to inductively transfer the telephones speaker audio signal to a “T” coil equipped hearing aid.

3) A method whereby a semiconducting ferrite core/coil is powered entirely by the telephone handset speaker, with the intent to inductively transfer the telephones speaker audio signal to a “T” coil equipped hearing aid.

4) A method where the inductive output from a semiconducting core/coil is controlled by a circuit to limit operation to 8 Khz, with the final intent being to transfer an audio signal to a “T” coil equipped hearing aid.

5) A method whereby a inductive coil is created around and about a semiconducting ferrite core, and it's intent being that to inductively transfer an audio signal to a “T” coil equipped hearing aid.
